(19) United States
(12) Patent Application Publication
(10) Pub. No.: US 2014/0034797 A1
(43) Pub. Date: Feb. 6, 2014

(54) TOWEL HOLDER

(71) Applicant: Terry MARKWARDT, Austin, TX (US)

(72) Inventor: Terry MARKWARDT, Austin, TX (US)

(21) Appl. No.: 13/955,573

(22) Filed: Jul. 31, 2013

Related U.S. Application Data
(60) Provisional application No. 61/678,000, filed on Jul. 31, 2012.

(51) Int. Cl. F16M 13/02; F16M 13/04

(52) U.S. Cl. CPC F16M 13/02; F16M 13/04
USPC 248/231.81

(57) ABSTRACT

An improved towel holder, which can be used with any towel, is easily releasable, can be easily attached to a users clothing, backpack, etc., and can also be easily mounted onto a wall or other stationary object. A towel holder according to preferred embodiments of the present invention is generally a hollow, cylindrical tube having a plurality of flexible “teeth” in the center of its front face, with an attached clip on its back face suitable for attachment to a belt or clothing. The clip can also easily be used with a wall mounting bracket, allowing the towel holder to be clipped to the wall bracket for storage or for stationary use. The teeth are preferably flexible so that a portion of a towel or cloth can be pushed between the teeth, which will then grip and hold the towel in place. The towel can then be easily disengaged with a simple one hand manual pulling action.

### CROSS REFERENCE TO RELATED APPLICATION

The present application claims priority from U.S. Provisional Patent Application No. 61/678,000, filed Jul. 31, 2012, entitled “Towel Holder,” naming inventor Terry Markwardt, which application is incorporated by reference herein in its entirety.

### FIELD OF THE DISCLOSURE

This disclosure, in general, relates to a towel holder, and in particular to a towel holder attached to ones body or to a surface such as a wall and in which a towel can easily be inserted into the holder with as little effort as pressing with one finger.

### BACKGROUND

Towels which are designed to be attached to the belt or pants of a wearer are well known. Prior art designs, however, typically make use of a clip or snap-type fastener that is either permanently attached to the towel or make use of a reinforcing ring on the towel itself. Such prior art towel holders are also typically only intended for attachment to the user's clothes or to something with similar types of straps or belts, such as a golf bag.

As such, an improved towel holder would be desirable.

### SUMMARY OF THE INVENTION

A preferred embodiment of the present invention is directed to an improved towel holder, which can be used with any towel, is easily releasable, can be easily attached to a users clothing, backpack, etc., and can also be easily mounted onto a wall or other stationary object. A towel holder according to preferred embodiments of the present invention is generally a hollow, cylindrical tube having a plurality of flexible “teeth” in the center of its front face, with an attached clip on its back face suitable for attachment to a belt or clothing. The clip can also easily be used with a wall mounting bracket, allowing the towel holder to be clipped to the wall bracket for storage or for stationary use. The teeth are preferably flexible so that a portion of a towel or cloth can be pushed between the teeth, which will then grip and hold the towel in place. The towel can then be easily disengaged with a simple one hand manual pulling action.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The present disclosure may be better understood, and its numerous features and advantages made apparent to those skilled in the art by referencing the accompanying drawings.

FIG. 1A is a front view of a towel holder according to a preferred embodiment of the present invention.

FIG. 1B is a perspective view of the towel holder of FIG. 1A.

FIG. 2 is a back perspective view of a molded body according to a preferred embodiment of the present invention.

FIG. 3A is rear perspective of an insert according to a preferred embodiment of the present invention.

FIG. 3B is front view thereof the insert.

FIG. 3C is a side view thereof of the insert

FIG. 4A is a perspective view of the towel holder showing the towel holder body and insert separated according to a preferred embodiment of the present invention.

FIG. 4B is a rearward perspective view thereof.

FIG. 5 is a bottom view of the towel holder according to a preferred embodiment of the present invention.

FIGS. 6A-6B and 7A-7B are solid model drawings of a towel holder according to a preferred embodiment of the present invention.

FIG. 8 is a side view of a towel holder according to a preferred embodiment of the present invention.

FIG. 9 is a top-down view of a towel holder according to a preferred embodiment of the present invention.

FIG. 10 is a rear perspective view a towel holder with a belt clip according to a preferred embodiment of the present invention.

FIG. 11 is a front view of the towel holder of FIG. 1A with a towel attached.

FIG. 12 shows the towel holder in use with the belt clip attached at a user's waist and with a towel pushed into the teeth of the towel holder.

FIG. 13 shows the direction of force used to insert a towel into a towel holder according to the present invention.

FIGS. 14-16 show a wall bracket suitable for use with embodiments of the present invention.

FIG. 17 shows another preferred embodiment of the present invention in which the flexible insert includes six separate gripping teeth.

The accompanying drawings are not intended to be drawn to scale. In the drawings, each identical or nearly identical component that is illustrated in various figures is represented by a like numeral. For purposes of clarity, not every component may be labeled in every drawing.

### DESCRIPTION OF THE DRAWINGS

Preferred embodiments of the present invention provide an improved towel holder, which can be used with any towel, is easily releasable, can be easily attached to a users clothing, backpack, etc., and can also be easily mounted onto a wall or other stationary object. Such a clip-on towel tote can be useful for sports and other activities, such as general cleaning, cooking, grilling, painting, gardening, bartending, table waiting, etc., where having a readily accessible towel is advantageous. Embodiments of the invention provide a quick attachment and release means for toweling and the like which comprises a receiver means provided with a plurality of flexible “teeth” adapted to be affixed to a ridged body structure having a clip suitable for attachment to a belt or clothing.

The following description is provided to enable any person to make use of the invention described herein and sets forth the best modes contemplated by the inventor of carrying out this invention. As is customary, it will be understood that no limitation of the scope of the invention is thereby intended. Further modifications will remain apparent to those skilled in the art since the generic principles of the present invention have been defined specifically to provide a portable towel holder that can be easily operated with one hand and used with virtually any appropriately sized towel or cloth.

A clip-on towel tote according to embodiments of the present invention provides a gripping means for holding a towel or rag. The towel can be held in place by manually inserting or pressing the towel into the towel tote mouth so that a portion of the towel is pushed past a plurality of flexible “teeth,” which then grip and hold the towel. The insertion of the towel into the holder preferably requires little effort, and can be easily accomplished by using a finger to push a portion of the towel into the teeth of the holder. The towel can then be easily disengaged with a simple one hand manual pulling action. The clip-on towel tote preferably includes a belt clip suitable for attaching the towel tote to a person's belt, pocket, purse, or other suitable article. Additionally, the towel tote is preferably supplied with a wall mountable bracket which can be used as a stationary towel holder or simply used to store the towel tote. A further advantage of a towel tote according to the present invention is that the holder body can be offered in various colors to match the wearer's attire.

This system has the advantage over other towel holders as it is portable and helps keep a towel by the wears side ready for use, and can be easily used with one hand while not requiring a specialized towel (such as a golf towel with a grommet). The wearer does not need to put a dirty or wet towel in their pocket, over their shoulder, lay it down or misplace it. In sports situations, such as golfing, there often are particularly instances where the ground is wet from dew or rain, and the golfer may need to take the towel with him/her onto the green to dry or clean the golf ball or club. A golf bag or cart is not allowed onto the green, and without a way to easily secure the towel in a quick manner to one's body, the only other option is to lay the towel on the ground, where it will be exposed to wet grass and become soaked. The towel tote allows the golfer to keep a towel handy and clean without interfering with his/her movement.

Mechanics also need a way to keep a towel handy and not misplace it. Nothing is more frustrating than to need to wipe one's hands or clean grease or oil from a tool and not be able to quickly locate the towel, as having to get up from an awkward position to search for the towel is time consuming and frustrating.

Equally advantageous is the towel tote requires only one hand to operate, is light weight, is easily attached to and removed from the person's body, can secure the towel in a position on the waist that is easy to access and does not interfere with one's movement, and is low cost to produce.

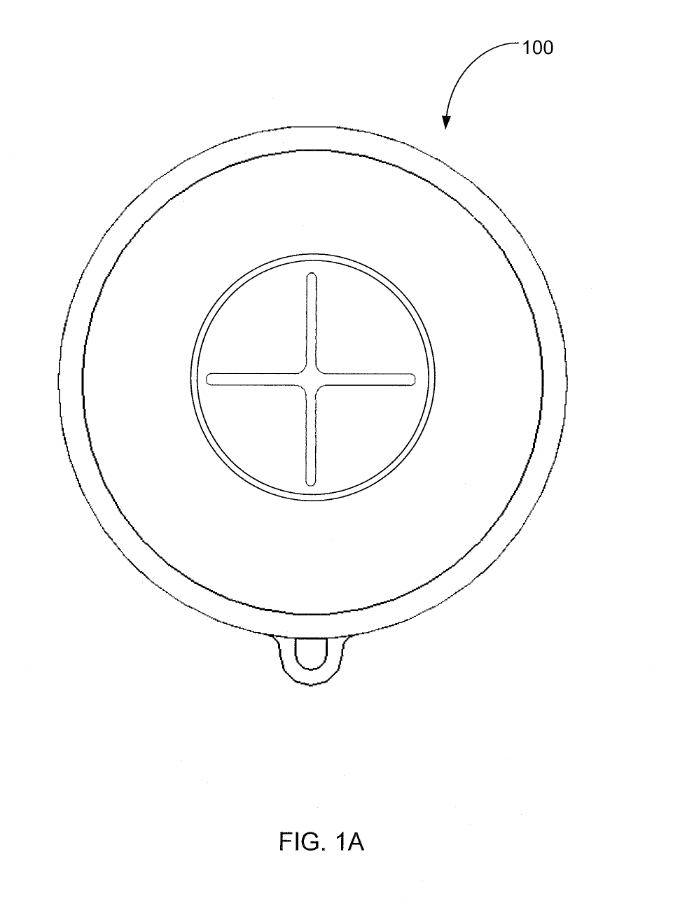

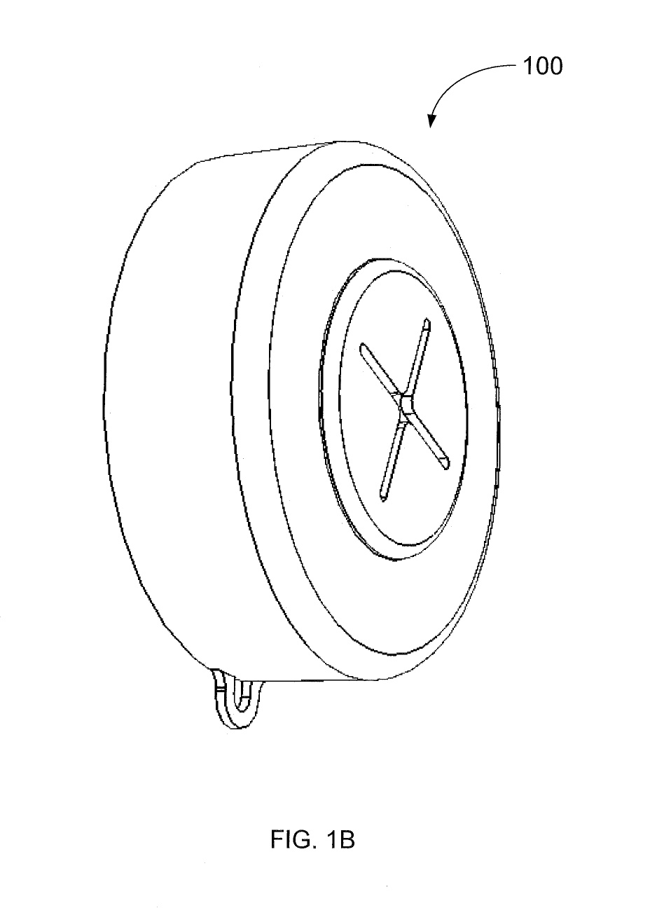

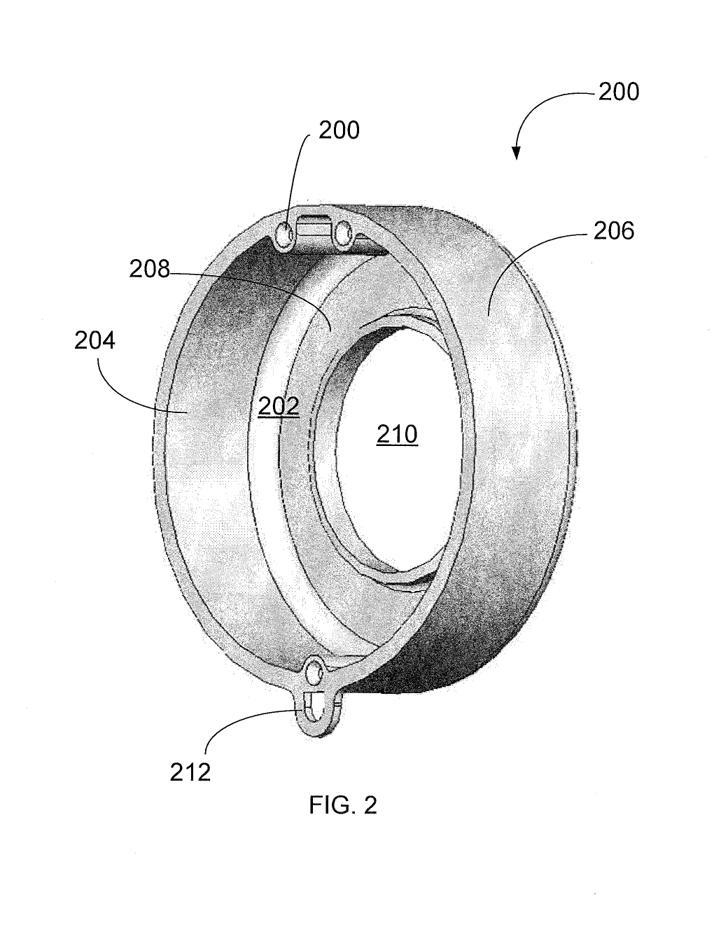

An exemplary front perspective view of a preferred embodiment of the towel holder 100 is shown in FIG. 1. As shown, the towel tote 100 is generally comprised of tote body 200 and insert 300. As shown in FIG. 2, the towel tote body 200 is generally a cylindrical housing having a central bore through its longitudinal axis, said housing comprising an inner volume 202. The housing comprises an inside surface 204, an outside surface 206, and a top surface or ceiling 208. In one preferred embodiment, said top surface has a generally circular centered opening 210 configured to accept an insert. As shown in FIG. 2, loop 212 allows keys or other accessories to be attached to the towel holder. In one preferred embodiment, belt clip insertion holes 214 allow a belt clip 400 to be fastenably attached to the body. In another preferred embodiment, belt clip 400 can be molded into the tote body.

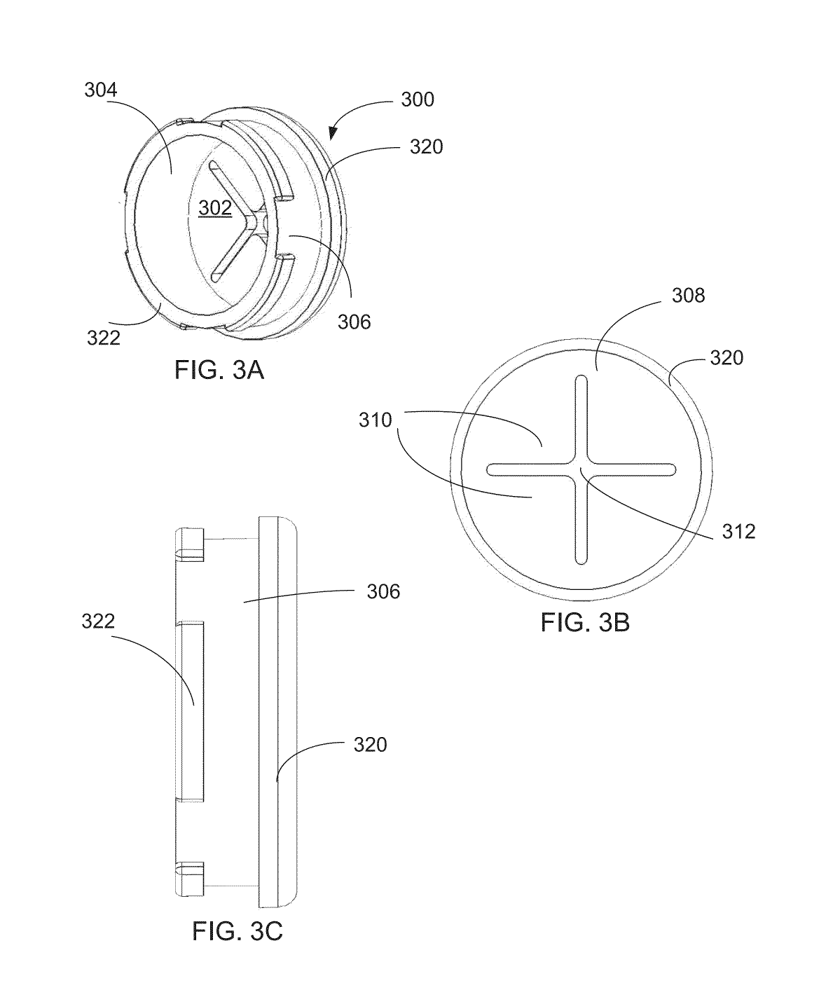

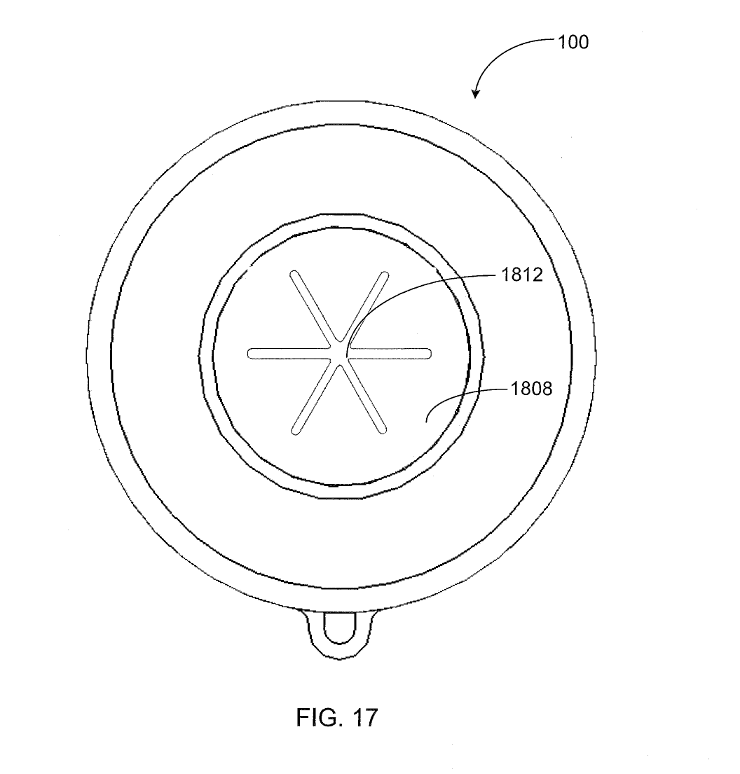

As shown in FIG. 3A-3C, insert 300 is a generally cylindrical housing having a central bore through its longitudinal axis and whose diameter is slightly less than the diameter of the tote body. Said housing comprises an inner volume 302. The insert body comprises an inside surface 304, an outside surface 306 and a top surface or ceiling 308 and is comprised of a flexible material. In one preferred embodiment, the insert top surface comprises a gripping mechanism comprised of teeth 310 which are formed in the surface by molding or removing material to create slot 312. The slot can be used to form any desired number of teeth. For example, the slot in FIG. 3 is generally cross shaped and forms four separate gripping teeth. In the preferred embodiment of FIG. 17, multiple intersecting slots are used form six separate gripping teeth. The insert can be formed from a flexible or elastic material that is flexible enough to allow the teeth to flex inward when pressed inwardly or to flex outward when the towel or cloth is pulled away from the holder.

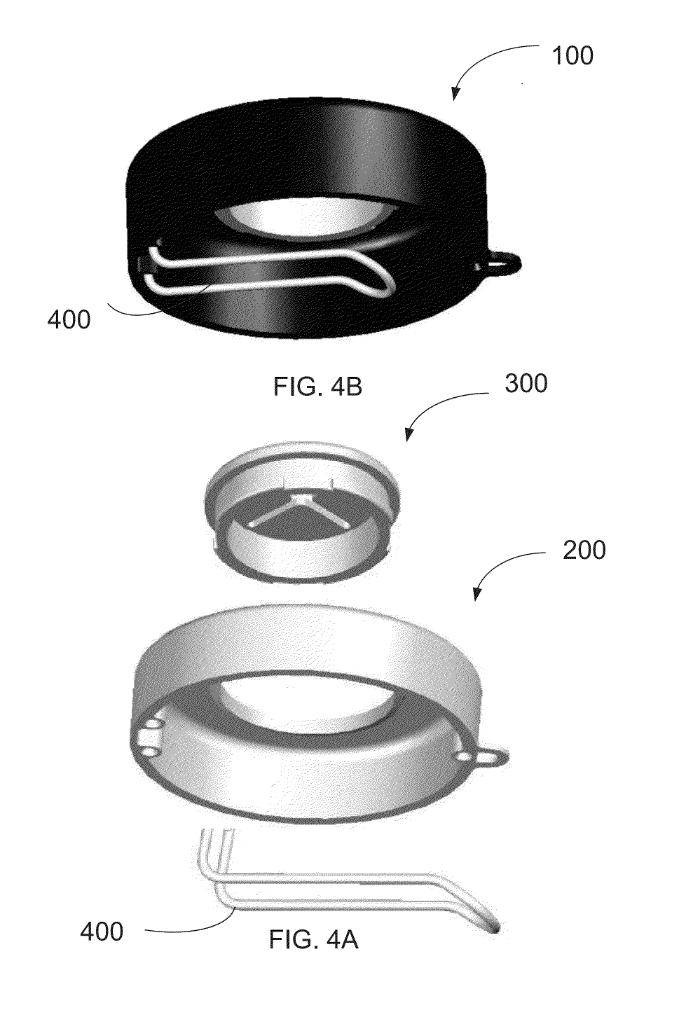

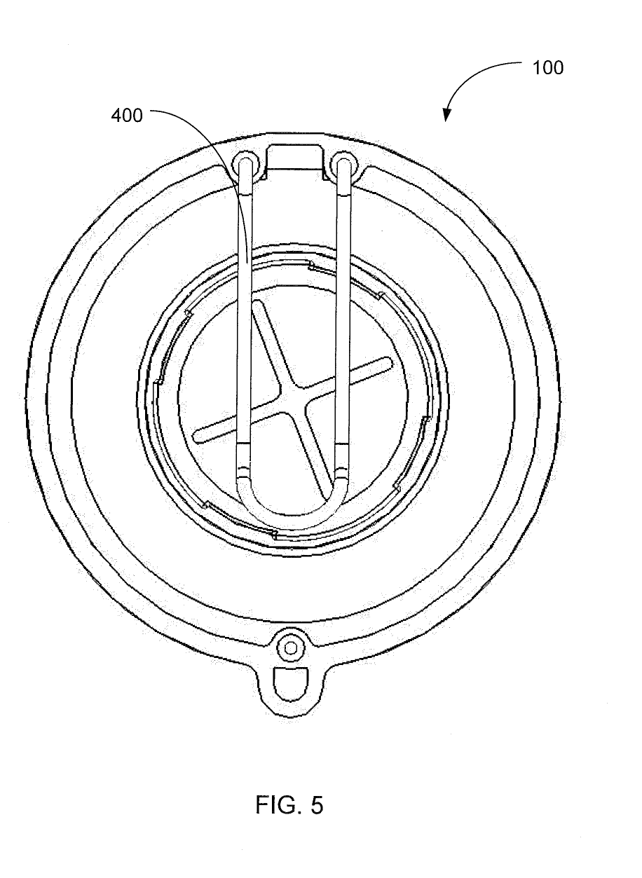

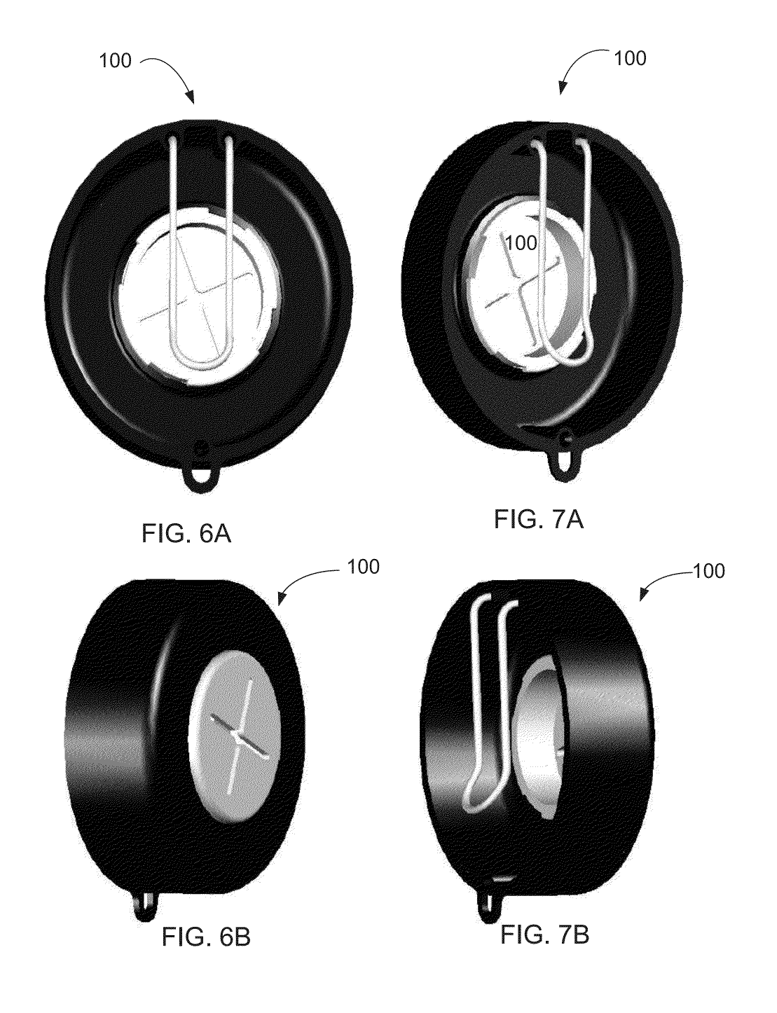

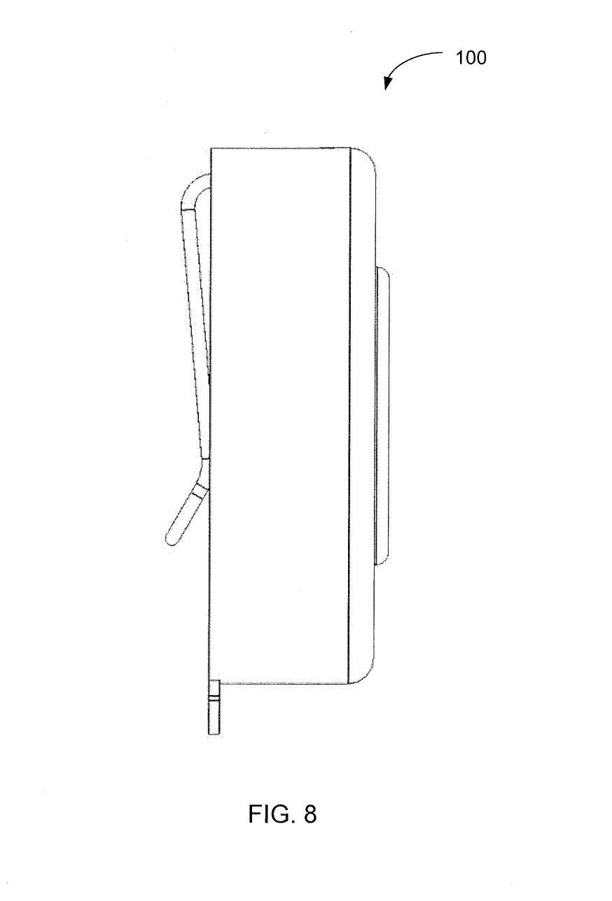

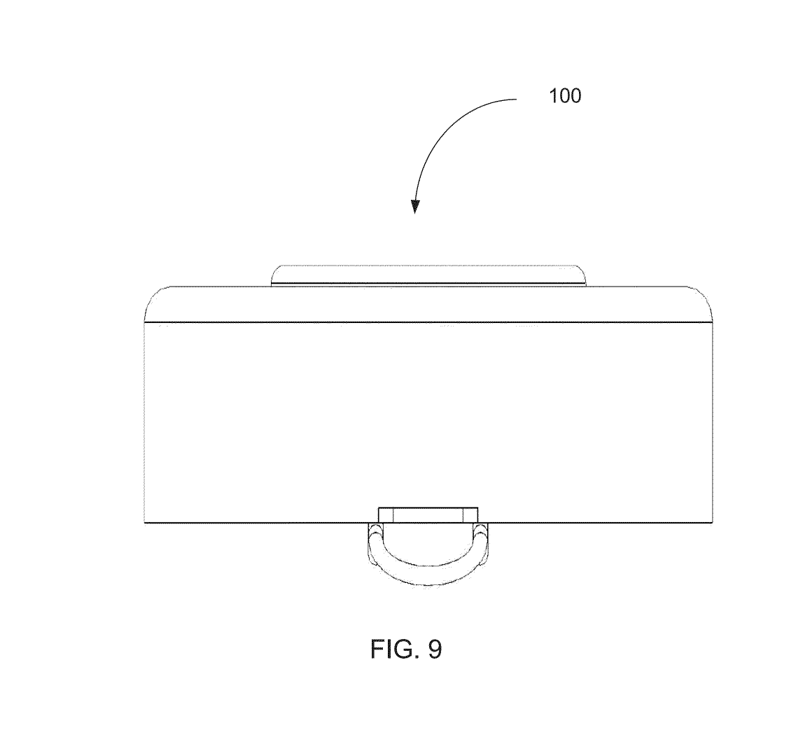

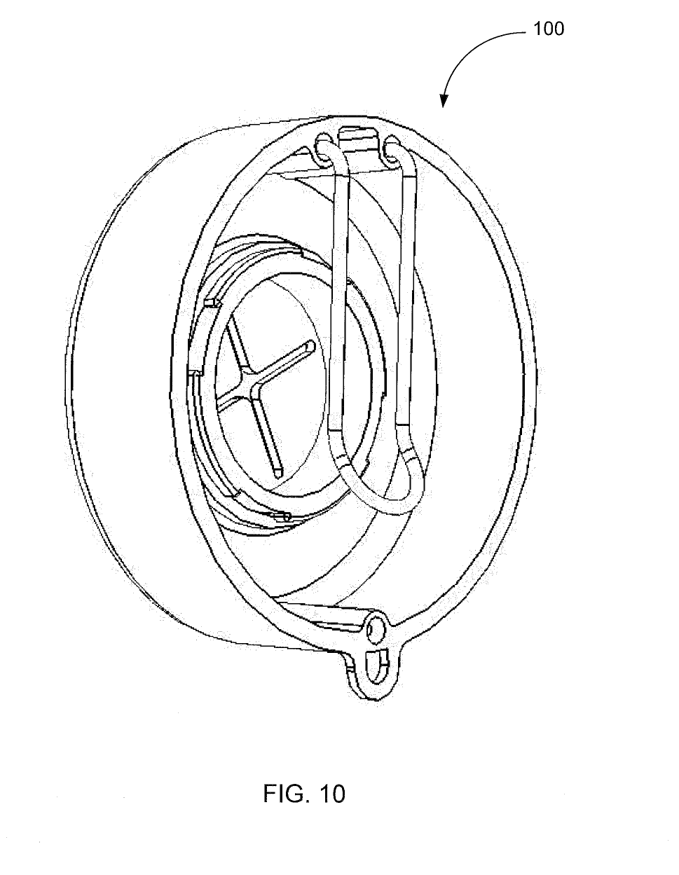

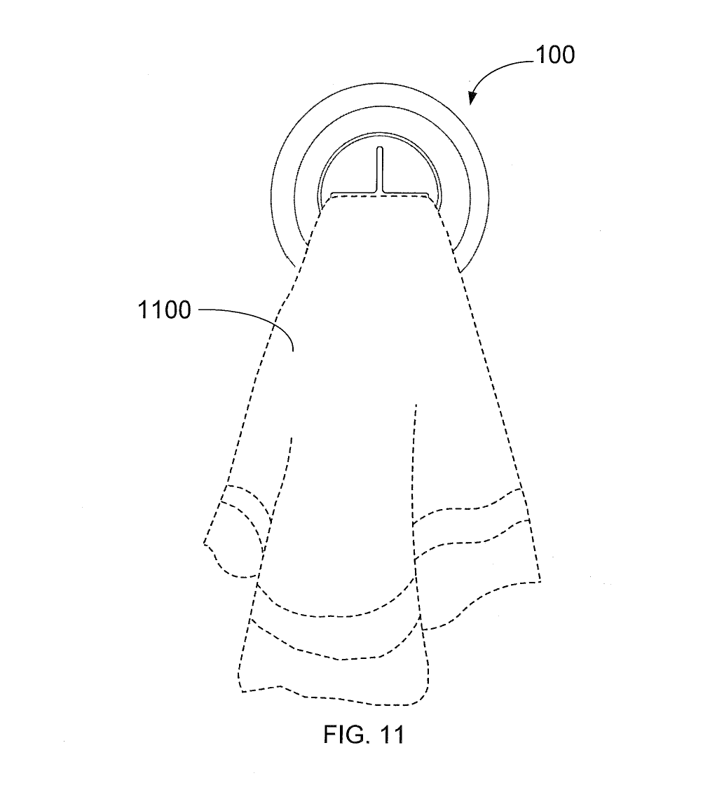

Belt clip 400, shown in FIGS. 4A and 4B, allows the user to secure the towel holder to the body to keep the towel handy and accessible. The belt clip can be made of metal or plastic or other semi-rigid material. In one preferred embodiment, body 200, insert 300 and belt clip 400 are molded or assembled separately. Insert 300 is placed inside the generally circular centered opening 210 and secured in place by upper latch 320 and lower latch 322. Belt clip 400 can then be then attached to body 200. In another preferred embodiment, the tote or holder is molded as one part and belt clip is insert molded into the body. Teeth 310 can then over molded onto the body.

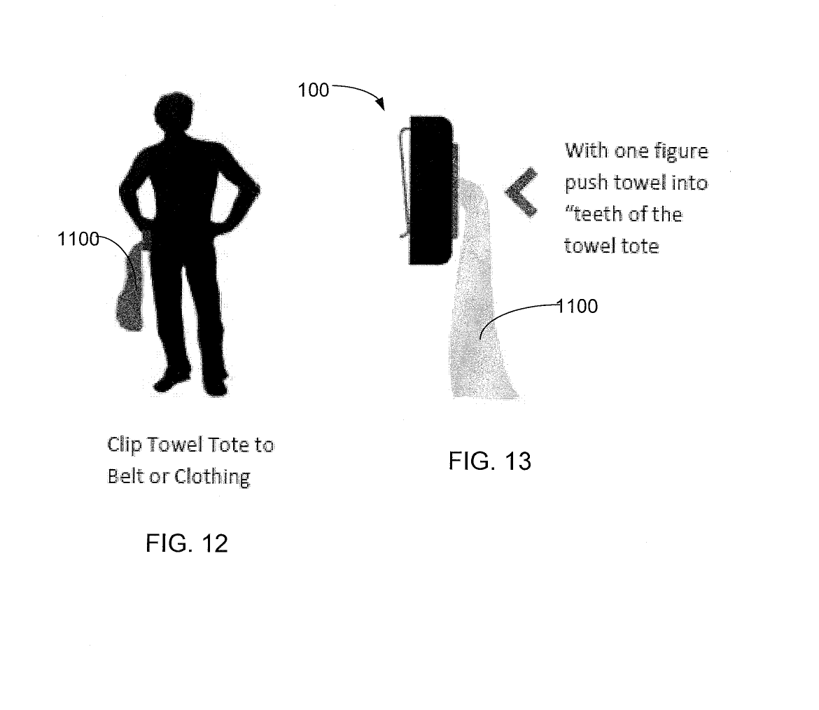

As shown in FIGS. 11-13, when a portion of a fabric 1100 such as a towel is pressed against the top surface of the insert, teeth 310 flex into the interior space of the tote body, wherein a portion of the fabric enters interior space and is secured by the teeth, until the user desires the fabric to be released. When the user desires to release the fabric from the towel holder, the user only has to assert a longitudinal force outwardly on the fabric, causing the fabric to be pulled out of the interior space of the tote body and disengage from the teeth. Preferably, the effort needed to pull and release the fabric is minimal and requires only one hand.

The towel tote body can be made of any suitable ridged material, including plastics, metals, ceramics, or wood. The gripping mechanism or flexible “teeth” can be made from a moldable or die cut rubber like material or pliable plastic such as EPDM, soft vinyl, SANTOPRENE or other thermoplastic vulcanizates (TPVs) having a suitable Shore Durometer Hardness for adequately gripping and holding the towel, yet flexible to prevent “biting” the user's finger when inserting the towel. The belt clip can be made from any suitable ridged material such as metal or plastic.

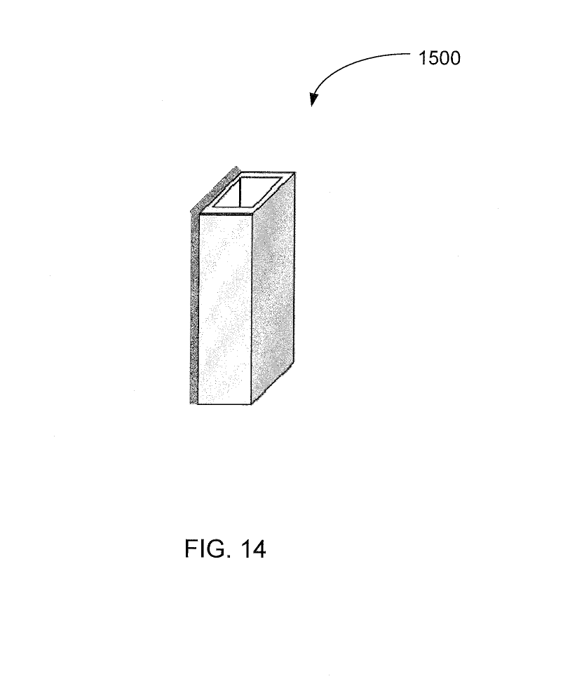

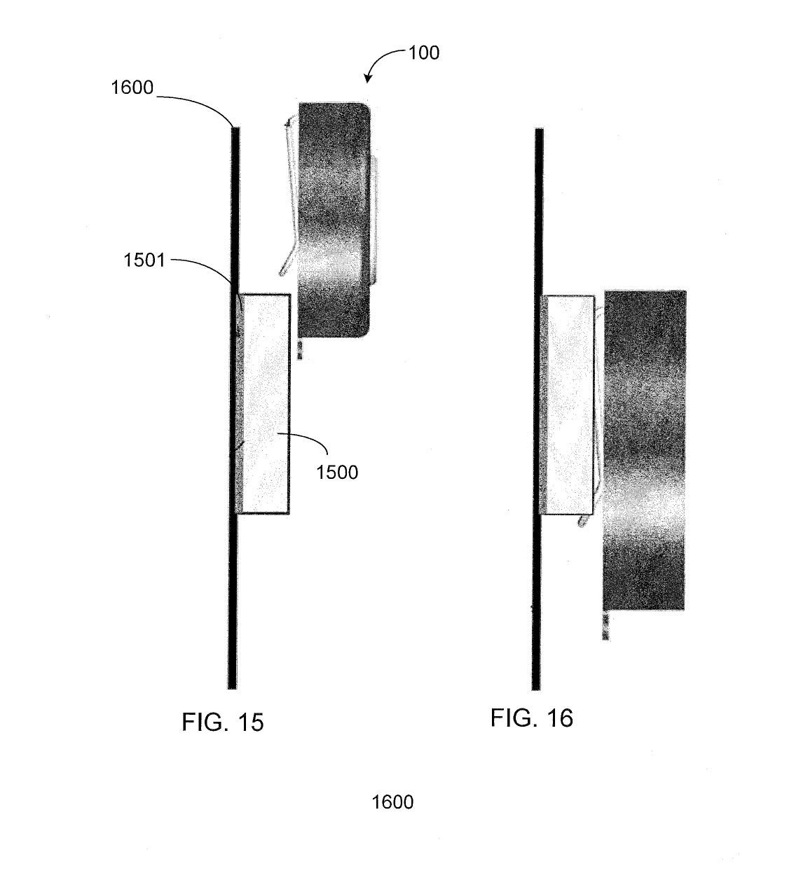

As shown in FIGS. 14-16, the towel tote is preferably supplied with a wall mountable bracket 1500, which can be used as a stationary towel holder or simply used to store the towel tote. The wall bracket can be attached to a surface or structure such as a wall 1600 with foam mounting tape 1501 or any other suitable attachment method, or can be clipped onto a structure such as a golf bag or golf cart (not shown), where it is held in place off of the floor or other surface like a table, and thus easily located and kept clean and dry. The wall mountable bracket can made from any suitable rigid material such as metal, plastic, or wood. As shown in FIGS. 15-16, once the wall bracket is in place, the towel tote can simply be clipped onto the bracket using the belt clip.

FIG. 17 shows another preferred embodiment of the present invention in which the flexible insert includes six separate gripping teeth. Any desired number of teeth could be used, as long as the teeth remain strong enough to adequately grip a towel or cloth.

The invention described herein has broad applicability and can provide many benefits as described and shown in the examples above. The embodiments will vary greatly depending upon the specific application, and not every embodiment will provide all of the benefits and meet all of the objectives that are achievable by the invention. Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

Although the features of the body and insert have been described with terms such as “cylindrical,” the shape of the holder may have equivalent configurations such as square, elliptical or other cross-sectional shape, whether symmetrical or asymmetrical.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. (canceled)

2. A towel holder comprising:
a body;
an insert;
a clip fixably attached to said body;
said body comprising a generally cylindrical housing having a central bore through its longitudinal axis, said housing further having an inside surface, an outside surface and a top surface;
said top surface of said body having a generally circular centered opening configured to accept said insert;
said insert comprising a generally cylindrical housing having a central bore through its longitudinal axis and said housing further having an inside surface, an outside surface and a top surface, the circumference of the insert housing being slightly smaller than the diameter of the body generally circular centered opening
said insert top surface having gripping mechanism comprised of teeth formed by slots radiating outwardly from a centrally located.
said teeth being generally suitable for gripping fabric; and
said teeth being flexible enough that a user can insert said fabric into the teeth for holding using only one finger.

3. The towel holder of claim 2 in which the body is comprised of a suitably rigid material.

4. The towel holder of claim 2 in which the body material can be plastics, metal, ceramics or wood.

5. The towel holder of claim 2 in which the insert is comprised of a moldable or die cut rubber like material or pliable plastic such as EPDM, softy vinyl, SANTOPREN or other thermoplastic vulcanizates having a suitable Shore Durometer hardness for adequately gripping and holding fabric yet flexible to prevent biting the user's fingers when inserting the fabric.

6. The towel holder of claim 2 in which the clip is comprised of any suitable rigid material such as metal or plastic.

7. The towel holder of claim 2 in which said towel holder is fixably attachable to a surface mountable bracket.
